(19) United States
(12) Patent Application Publication
(10) Pub. No.: US 2007/0216539 A1
(43) Pub. Date: Sep. 20, 2007

(54) System to warn of an approaching emergency vehicle

(76) Inventors: Jennifer D'ANTONI, Dublin, OH (US); Robert Scott MILLAR, Delaware, OH (US)

Correspondence Address: STANDLEY LAW GROUP LLP, 495 METRO PLACE SOUTH, SUITE 210, DUBLIN, OH, 43017, US

(21) Appl. No.: 11/548,816

(22) Filed: Oct. 12, 2006

Related U.S. Application Data
(60) Provisional application No. 60/596,672, filed on Oct. 12, 2005.
(60) Provisional application No. 60/821,747, filed on Aug. 8, 2006.

(51) Int. Cl. G08G 1/00

(52) U.S. Cl. 340/902

(57) ABSTRACT

A system for warning an occupant of a non-emergency vehicle of the approach of an emergency vehicle has a means for transmitting a signal, installed in the emergency vehicle, and a means for receiving the signal, installed in the non-emergency vehicle. The receiver is integrated into the electrical system of the non-emergency vehicle so that it is energized whenever an ignition system of the vehicle is engaged. When a transmitted signal, preferably a radio frequency signal, received by the receiver has a strength that exceeds a threshold strength, the receiver causes at least one of a visible or audible indicator in the non-emergency vehicle to be activated and remain activated as long as the signal is received at a strength above the threshold level. In many embodiments, the transmitter is activated anytime the emergency lights on the emergency vehicle are activated.

### CROSS-REFERENCE TO RELATED APPLICATIONS

This application is a non-provisional of U.S. provisional applications 60/596,672, filed 12 Oct. 2005 and 60/821,747, filed 8 Aug. 2006. A claim of priority is made to each of the provisional applications and the content of each is incorporated by reference as if fully recited herein.

### TECHNICAL FIELD

The present invention relates to a safety system for a vehicle. More particularly, it relates to a system allowing a driver of a vehicle to receive an on-board warning that an emergency vehicle is in the vicinity.

### BACKGROUND OF THE ART

It is well-known for emergency vehicles to be equipped with audible and visible indicators that warn of the vehicle's approach. However, there are known drawbacks and disadvantages to these indicators. A particular drawback is driver reliance on audible indicators, since the visible indicators are literally limited to “line of sight” use. In the US, there are presently about 80 deaths per year caused by crashes between emergency vehicles (while using their warning signals) and civilian vehicles.

Audible indicators are amazingly versatile, when they are able to be heard. For example, the Doppler effect associated with a siren can easily tell a driver whether the emergency vehicle is coming toward, or going away from, the vehicle. Unfortunately, there are many audible signals competing for a driver's attention. Cars are built to be quite sound-proof, and this especially enhanced in the extremes of summer and/or winter, when a vehicle's windows are unlikely to be open. Many vehicles are equipped with elaborate sound systems, having powerful speakers. Some drivers wear headphones while driving, to listen to music or talk on mobile phones. Other driver are actively engaged in conversation with their passengers. Some emergency vehicles observe a “no sirens” policy in some areas, as when they near a hospital, and police vehicles often refrain from use of sirens when responding to certain calls, such as robberies.

A certain percentage of drivers are simply hearing-impaired and require all the assistance they can get for the audible indicators. State driving licensure laws test a potential driver's vision, but a hearing test is not commonly a part of the test protocol.

Broadcasting a signal from an emergency vehicle to activate a visible indicator remote from the emergency vehicle is not unknown. At least one patent describes a system for activating warning lights around a traffic signal or controlling a traffic signal as an emergency vehicle approaches. However, traffic signals are not used at all intersections.

It is an unmet object of the prior art to provide a system to warn of the approach of an emergency vehicle, particularly where the warning emanates from the emergency vehicle and activates an on-board warning device in at least one vehicle in the proximity of the emergency vehicle.

### SUMMARY OF THE INVENTION

This and other unmet objects of the prior art are achieved by the embodiments disclosed herein.

In one embodiment, a system for warning an occupant of a non-emergency vehicle of the approach of an emergency vehicle, comprising a transmitting means and a receiving means. The transmitting means is installed in the emergency vehicle and the receiving means is installed in the non-emergency vehicle. The receiver is integrated into the electrical system of the non-emergency vehicle to be is energized whenever an ignition system of the vehicle is engaged

### BRIEF DESCRIPTION OF THE DRAWINGS

The present invention will be better understood when reference is made to the accompanying drawings, wherein identical parts are identified with identical part numbers and wherein:

FIG. 1 shows a schematic depiction of a scene employing the system of the present invention; and

FIG. 2 shows an elevation view of an automobile interior, equipped with a device of the present invention.

### DETAILED DESCRIPTION OF A PREFERRED EMBODIMENT

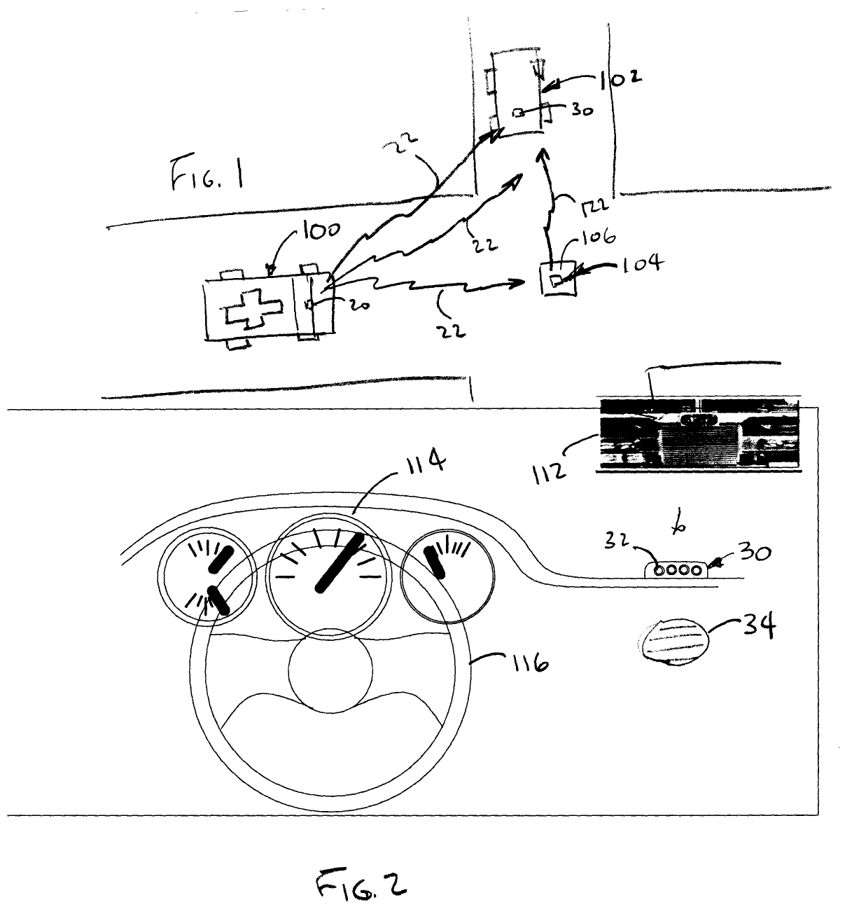

Directing attention first of FIG. 1, a system 10 incorporating the present invention is illustrated schematically. One embodiment of such a system 10 has a transmitter 20, which is installed in an emergency vehicle 100. The system also has at least one receiver 30, which is installed in a non-emergency vehicle 102. In an ideal embodiment, there will be a one-to-one correspondence between the receivers 30 and the non-emergency vehicles 102, but some non-emergency vehicles may not have a receiver and some non-emergency vehicles may have more than one receiver.

In using the term “emergency vehicle,” the inventors do not intend to limit themselves to the traditional definition, which would include police, fire and ambulance vehicles. The inventors would broaden this definition to include all vehicles that require enhanced attention of the driving public, and, particularly, all vehicles which try to educe this enhanced attention through the use of flashing lights. For example, the present invention should encompass vehicles that remove snow and spread salt and other ice-preventive materials on public roads, road maintenance vehicles, school buses and the like. In some aspects of the invention, a railroad train may use a transmitter 20 of the present invention to attract attention of drivers on roadways that cross the railway, especially at crossings that lack a cross-buck and/or flashing lights. In the US, there are many accidents annually as a result of unmarked crossings.

The transmitter 20 of the present invention is adapted to emit a signal 22, at a predetermined frequency, preferably in the radio-frequency portion of the spectrum. In an exemplary embodiment, the signal 22 emitted by transmitter 20 is a low-power signal that is intended for reception only by receivers 30 that are within a predetermined proximity of the emergency vehicle 100. In a typical embodiment, this proximity will be less than about one mile and may even be considerably less than that, but should be at least about 200 yards. It is clearly within the skill of those in the relevant art to equip an emergency vehicle with such a low-power transmitter 20. It is, in fact, well-known that all emergency vehicles are already equipped with emergency radio transmission equipment of the same type that is anticipated to be used for the present invention. It would be an exemplary embodiment of the present invention to incorporate the required transmission capability of transmitter 20 into the existing radio transmission equipment on the emergency vehicle 100 and to wire it so that activation of the emergency lights and siren of the emergency vehicle would automatically activate the transmitter 20.

In some embodiments of the invention, and particularly when the contours of the landscape or other considerations may mandate it, the entity operating the emergency vehicles 100 equipped with the transmitters may choose to also use one or more repeater stations 104 for disseminating the signal 22. For example, in communities where emergency vehicles 100 are equipped with the ability to take control over traffic signals during an emergency run, the same signal that takes control of a traffic signal 106 might also be used to send the signal 22 to receivers 30 in the vicinity. The repeater station 104 would send out a repeater signal 122, which could be received by receivers 30 in the vicinity.

In the present invention, the reception of a signal 22 by a receiver 30 causes the receiver to emit at least one visible indicator 32, at least one audible indicator 34, or both. The visible indicator 32 will be at least internal to the vehicle, and may also be external, as described in more detail below. The visible indicator may be preferred to the audible indicator. This is particularly the case when the receiver 30 is mounted in the non-emergency vehicle 102 in a manner that the visible indicator 32 is positioned to be visible in a “heads up” location in the driver's sight lines to the road ahead of the driver. An exemplary example of the visible indicator 32 is at least one light, particularly at least one light-emitting diode (“LED”) light, and more particularly, at least one flashing yellow LED light. An exemplary example of an audible indicator 34 would be a undulating sound device.

In an exemplary embodiment, the receiver 30 would be installed as a standard feature in all non-emergency vehicles 102, although early in the introduction of the systems, it would probably be necessary to have the receivers retro-fitted into some existing vehicles.

FIG. 2 shows a typical dashboard 110 of a non-emergency vehicle 102 with the receiver 30 installed. In a central location as shown in FIG. 2, the receiver could have the visual indicator 32 located atop the dashboard below the rear-view mirror 112, near standard features such as instrument panel 114 and steering wheel 116. It is not essential to the invention to have the visual indicator 32 immediately proximate to the receiving electronics of the device. In many cases, it may be advantageous to position the receiving electronics of the receiver 30 proximate to, or even in a shared relationship with, the standard radio frequency receiving device installed in the vehicle. For example, the receiver 30 could clearly share the use of a power supply, antenna, and possible even the speakers, which could serve as a platform for the audible indicator 34.

A particularly preferred embodiment of the present invention may be a system in which the receiver 30 is interfaced extensively with the standard electrical systems of the vehicle 102 and advantageously uses the electrical capabilities of the vehicle. Such an embodiment may use the reception of a signal at the receiver to cause one or more actions that will immediately attract the driver's attention. For example, the receiver 20 may activate the “four-way” flasher system of the vehicle 102. This action would have several results. First, it would activate a flashing signal on the instrument panel. Second, it would provide a signal to other drivers. Indeed, a significant aspect of the present invention is to assist drivers in other vehicles in recognizing the approach of the emergency vehicle, because, especially in the early years of introduction of the invention in the market, a significant number of non-emergency vehicles on the road would lack a receiver 30. It is known in the art that drivers who are unaware of the emergency vehicle are a danger not only to the emergency vehicle, but also to the other non-emergency vehicles, especially those non-emergency vehicles where the driver is acting to get out of the way of the emergency vehicle. In a particularly preferred embodiment, the activation of the “four way” flashes (or similar lights on the non-emergency vehicle) may be done to provide a distinctive flashing pattern that would be recognizably different from the standard operation of those lights. In another preferred embodiment, the reception by the receiver 30 of a signal from an emergency vehicle would operate to kill power to the radio, at least until the reception of the signal is acknowledged by the driver. This serves to attract driver attention.

An exemplary embodiment of the receiver 30 would be capable of receiving a signal on at least one frequency to activate the visual and/or audible indicator 32, 34. The advantage of using more than one frequency is that adjacent communities (and even adjacent emergency units, such as fire stations) could use different frequencies without interfering with each other. When more than one transmitting frequency is being used, it is particularly advantageous if the receiver 30 has a frequency-scanning capability, so that all possible frequencies are being scanned on a regular manner.

Exemplary embodiments of the present invention would be hard-wired into the electrical system of the non-emergency vehicle 102. In this manner, the receiver 30 would automatically be energized whenever the ignition switch is moved to a position that energizes any of the electrical functions of the vehicle 102. It would preferably not be equipped with a power switch that would allow the receiver to be turned off manually, but it would preferably be equipped with an “acknowledge” button. Such a button would acknowledge the reception of a signal and would silence the visible and or audible indicators 32, 34 for a period of time after the acknowledge button is activated. A typical period would be in the range of about two minutes, after which the indicators would again be activated. The existing hazard warning system activation/deactivation button could be used for this purpose. In some embodiments, it might be preferred to keep any external visible indicators operating until the emergency vehicle transmitting the signal moves out of range.

In some of the prior art solutions to the problem solved by the present invention, the receivers that would be installed in the non-emergency vehicles are sophisticated devices that do detailed manipulation of the received signal, so that the precise location, direction of approach, and even the number of the emergency vehicles involved would be visually and/or audibly presented to the driver. In contrast to that philosophy, the present invention, in its preferred embodiments, would place an inexpensive but reliable device as a receiver in each non-emergency vehicle, the receiver having an objective of not attracting attention to itself, but instead to cause the driver to understand that enhanced attention to the immediate surroundings outside of the vehicle is warranted.

In some embodiments of the present invention, it would be desirable to use the Doppler shift inherent in the signal 22 to visually or audibly indicate to occupants of the non-emergency vehicle 102 whether the emergency vehicle 100 sending the signal is approaching or moving away from the non-emergency vehicle.

What is claimed is:

1. A system for warning an occupant of a non-emergency vehicle of the approach of an emergency vehicle, the system comprising:
a means for transmitting a signal, the transmitting means installed in the emergency vehicle; and
a means for receiving the signal, installed in the non-emergency vehicle, the receiver being integrated into the electrical system of the non-emergency vehicle such that the receiver is energized whenever an ignition system of the vehicle is engaged.

2. The system of claim 1, wherein:
the transmitted signal is in the radio frequency band of the electromagnetic spectrum.

3. The system of claim 2, wherein:
the receiver is adapted to scan a band of radio frequencies for receiving signals from emergency vehicles.

4. The system of claim 3, wherein:
upon receipt of the signal from an emergency vehicle, the receiver causes a signal to be transmitted to the electrical system of the non-emergency vehicle.

5. The system of claim 4, wherein:
the signal transmitted to the electrical system causes the hazard warning flashers of the non-emergency vehicle to be activated.

6. The system of claim 4, wherein:
the signal transmitted to the electrical system either mutes an audio system of the non-emergency vehicle or de-energizes the audio system.

7. The system of claim 4, wherein:
the signal transmitted to the electrical system activates a visible indicator inside a cabin of the non-emergency vehicle.

8. The system of claim 7, wherein:
the visible indicator is positioned in a normal sight line of a driver of the non-emergency vehicle.

9. The system of claim 1, wherein:
the receiver is integrated into an audio system of the non-emergency vehicle.

10. The system of claim 4, wherein:
the signal transmitted to the electrical system commences once the received signal from the emergency vehicle exceeds a pre-determined threshold strength and continues so long as the signal remains above the threshold strength.

11. The system of claim 10, wherein:
the receiver comprises a means for the driver to acknowledge the signal transmitted to the electrical system and to suppress the transmitted signal to the electrical system for a pre-determined period of time after the acknowledging means is actuated.

12. The system of claim 1, wherein:
the transmitted signal has a power level such that it exceeds a pre-determined threshold reception strength only in receivers located within about 1 mile of the emergency vehicle.

13. The system of claim 1, wherein:
the transmitter emits the signal whenever a set of emergency lights on the emergency vehicle are activated.

14. A method for warning an occupant of a non-emergency vehicle of the approach of an emergency vehicle, comprising the steps of:
providing the emergency vehicle with a means for transmitting a signal, the transmitting means selectively activated by an operator of the emergency vehicle;
providing the non-emergency vehicle with a means for receiving the signal, the receiver being integrated into the electrical system of the non-emergency vehicle such that the receiver is energized whenever an ignition system of the vehicle is engaged; and
configuring the receiver so that it transmits a signal to the electrical system of the non-emergency vehicle whenever the received signal from the emergency vehicle exceeds a pre-determined threshold strength, the signal transmitted to the electrical system so long as the transmitted signal remains above the threshold strength.
